(19) United States
(12) Patent Application Publication
(10) Pub. No.: US 2023/0361432 A1
(43) Pub. Date: Nov. 9, 2023

(54) SEPARATOR ARRANGEMENT FOR A BATTERY

(71) Applicant: L-Europe AG, Chur (CH)

(72) Inventor: Thomas KREIMER, Chur (CH)

(21) Appl. No.: 18/043,416

(22) PCT Filed: Aug. 28, 2020
(86) PCT No.: PCT/EP2020/074106

§ 371 Date: Feb. 28, 2023

(51) Int. Cl. H01M 50/491; H01M 50/449; H01M 50/403; H01M 50/414

(52) U.S. Cl. CPC H01M 50/491; H01M 50/449; H01M 50/403; H01M 50/414

(57) ABSTRACT

A separator arrangement for a battery comprises a porous separator with a separator porosity, and a porous filter with a filter porosity less than the separator porosity. For manufacturing a separator arrangement filter material is rolled off from a filter roll. The unrolled portion of the filter material is arranged in a first position. Separator material is rolled off from a separator roll. The unrolled portion of the separator material is arranged in the first position next to the unrolled portion of the filter material. The filter material and the separator material are cut off whereby the separator arrangement is formed.

### TECHNICAL FIELD

The invention relates to a separator arrangement, to a battery comprising such a separator arrangement, to a method for manufacturing a separator arrangement, and to a method for manufacturing a battery.

### BACKGROUND ART

In batteries, a separator is an important element for electrically separating anode and cathode. While on the one hand, the separator shall avoid short circuits, on the other hand, the separator shall allow ions passing in form of a permeable membrane.

Conventional separators are made from non-woven fibres or from ceramic. Such materials can only be manufactured at thicknesses of 25 μm or more. Yet, the thickness of such separator impacts the flow of the ionic charge carriers there through. In combination with a given number of pores and, hence, a given porosity of the material of the separator, the separator defines the degree of exchange of charge carriers as well as the speed of such exchange. The number of pores in such conventional separator materials are e.g. in the order of 1000-1500 per cm². Overall, the porosity and the thickness of the separator as provided in the art finally limits the charging time of the battery in case of an accumulator, and in particular prevents from faster charging times.

Recent developments enabled the manufacturing of polymer separators of a thickness considerably smaller than 25 μm, and with an increased porosity. Such separators promote an increased exchange of ionic charge carriers, which is desired for swifter charging a rechargeable battery containing such a separator. However, such thin and porous separator may suffer from an increased bias towards short circuits. In particular, such separators were found to be prone to the formation of dendrites, i.e. pin shaped electrical structures generated between the electrodes over time. Also other elements of the battery may not be suited yet for such a swift charge carrier exchange. In particular, elements of the battery may not yet withstand the increased heat generated during short charging times.

Accordingly, it is desired to still employ such a thin, high-porous separator in a battery.

### DISCLOSURE OF THE INVENTION

This object is solved by a separator arrangement which comprises a porous separator with a separator porosity, and, in addition to the separator, a porous filter with a filter porosity less than the separator porosity. Accordingly, instead of a stand-alone separator, a combination of a separator and an additional filter is proposed. The filter is an element in the separator arrangement controlling the flux of ions through the separator arrangement, which shall be defined as rate of flow of ions through the separator arrangement per area. In particular, the filter decreases the flux of ions through the separator arrangement in comparison with a separator-only approach. For this reason, the porosity of the filter is dimensioned less than the porosity of the separator which effects a reduction of the flux of ionic charge carriers transiting the separator arrangement compared to the flux at which the separator on its own would be transited. Hence, the filter preferably acts as decelerator for ionic charge carriers on their way from anode to cathode or vice versa. In addition, it was found that such filter reduces the formation of dendrites between the anode and the cathode.

However, not only the porosity of the filter adjusts the flux of the charge carriers through the separator arrangement. Also the thickness of the filter contributes to such effect given that a thicker barrier has to be overcome compared to the thickness of the separator only. This in turn makes the separator arrangement also more robust against short circuits. In addition the filter may mechanically support the separator. In view of the reduced thickness of the separator, it may be desired for bare mechanical stability and durability to have the separator mechanically supported by the additional element, i.e. the filter. In one example, the separator may be attached to the filter, e.g. by glue. In a different embodiment, the separator is not permanently fixed to the filter but only rests in a position in parallel to the filter.

For these reasons, while a thickness of the separator only preferably is less than 10 μm, a thickness of the filter preferably is equal to or more than 10 μm. More specifically, the thickness of the separator is between 6 μm and 8 μm, whereas the thickness of the filter preferably is less than 35 μm, and preferably less than 20 μm.

The resulting separator arrangement still provides for a swift transport of ionic charge carriers enabling shorter charging times while at the same time dendrites are avoided and the anode and the cathode are electrically separated for preventing short circuits. The overall thickness of the separator arrangement still is beneficial compared to most conventional separators and hence saves space in the housing of a battery.

Preferably, the filter porosity not only is smaller than the separator porosity but differs from the separator porosity by a defined margin. In one embodiment, this margin is at least 10%, in a different embodiment at least 20%, and even more preferably at least 25%.

In absolute numbers, it is preferred that the porosity of the separator is 50% or more, while the porosity of the filter is less than 50%. In a different embodiment, the separator porosity is 60% or more, and the filter porosity is less than 60%. Specifically, in such embodiment, the filter porosity is less than 40%. In the latter example, the separator porosity exceeds the filter porosity by at least 20%. In a further embodiment, the separator porosity is 70% or more, and the filter porosity is less than 70%, and specifically is less than 30%. In the latter example, the separator porosity exceeds the filter porosity by at least 40%. Porosity as such is defined as a ratio of voids in a material accessible from its surface over a total volume of the material.

Preferably, the separator is a flat element with a plane extension of length and width, each exceeding its height by far. So is the filter; i.e. the filter shows a plane extension of length and width each exceeding its height be far. In particular, the plane dimensions of the separator and the filter match, i.e. the length and the width of the filter are equal to the length and the width of the separator. In addition, it is preferred that the separator and the filter are arranged co-planar in a stack such that, in orthogonal direction, the separator is fully covered by the filter. This provides that any flux of ions have to pass the separator and the filter. This implies, that no detour is allowed for ions other than through the filter.

As to the numbers of pores in the separator, also referred to as density, it is preferred that the separator comprises more than 2000 pores per cm², whereas the filter comprises less than 2000 pores per cm². In particular, the separator comprises more than 3000 pores per cm², and the filter comprises less than 1500 pores per cm². In the most preferred embodiment, the separator comprises more than 4800 pores per cm², and the filter comprises less than 1200 pores per cm². These numbers are preferred in achieving the desired porosities as laid out above, which result in a swift charging time while providing sufficient electrical and mechanical stability at the same time.

Preferably, the pores of the separator are of uniform size. Uniform in this context shall be defined that at least 95% of the pores are within 10% of a given diameter. Preferably a diameter of the pores of the separator is between 5 μm and 95 μm. In particular, the diameter of the pores of the separator is less than 25 μm, and hence preferably between 5 μm and 25 μm.

Preferably, the pores are not only of equal diameter/size, but are also arranged equidistant from each other, e.g. in rows and columns.

In one embodiment, in particular for reaching a number of pores of 2000 per cm², the separator is manufactured by the following method: A printing technique is applied for printing elements such as circle-shaped dots onto a foil which later shall serve as separator. Other shapes of the elements are possible. In a further step, the printed foil is irradiated such that the printed elements melt and generate holes in the foil, which holes act as pores of the separator. The ink the elements are printed with preferably comprises a material inflammable in response to the radiation, such that holes with a defined diameter are generated. Preferably, a laser or laser bar is used for the irradiation. Preferably, the wavelength emitted by the laser or laser bar is in the infrared range. Preferably, the holes are only generated at locations where the irradiation meets the ink, but not outside. Hence, it is preferred that the irradiation triggers a thermodynamic reaction in the printed ink, but only there, not outside the ink dots/elements. This effect can be achieved or enhanced when adding metal particles to the ink absorbing the infrared radiation. Hence, even if a laser bar irradiates the entire foil, only the locations wetted by ink transform into holes/pores. Preferably, the foil is moved relative to the laser bar.

The device for printing the elements onto the foil preferably is a cylinder with a pattern of indentations, or micron sized recessed dots, on its outer surface. The cylinder preferably is made from steel and is coated with a layer of copper, e.g. by electroplating, e.g. of at least 200 μm. The indentations preferably are generated in the layer of copper by way of a laser. In order to generate an indentation diameter and an indentation density resulting in the mentioned pore diameter and density ranges, it is preferred that a resolution of the laser is in the range of 2 μm to 12 μm. Hence, the cylinder can be considered to be engraved. A depth of the indentations preferably is between 5 μm and 90 μm. The pattern of indentations in the cylinder is used to transfer ink at defined positions onto the foil or substrate. For this purpose, the cylinder is wetted by the ink, which ink preferably is a fluid ink based on water. Accordingly, the indentations are filled by the ink and the ink remains in the indentations due to surface tension. The ink wetted cylinder then is rolled over the foil such that the ink is transferred from the various indentations onto the foil and an ink pattern is generated on the foil that corresponds to the pattern of indentation on the cylinder. The result is a foil with ink printed elements, such as dots, corresponding to the pattern on the cylinder. The resulting separator is a foil with pore sizes in the above range, and a hole density in the above range.

Preferably, the material used for the foil, and hence the separator, is one of PE (polyethylene), PET (polyethylene terephthalate), in particular a Hostaphan foil, PETP (polyethylene terephthalate polyester), PP (polypropylene) or OPP (oriented polypropylene). Such material withstands heat of at least 130° C., preferably of at least 175° C. Preferably, the separator shows a tension resistance of at least 1 Nm.

In one embodiment, the pores of the filter are also of uniform size, and may be arranged equidistant. However, in a different embodiment, the pores of the filter are of non-uniform size, and/or are not arranged equidistant. Preferably, a diameter of the non-uniform sized pores of the filter is in the range between 0.02 μm and 0.7 μm.

Preferably, the material used for the filter is one of PE (polyethylene), PET (polyethylene terephthalate), in particular a Hostaphan foil, PETP (polyethylene terephthalate polyester), PP (polypropylene) or OPP (oriented polypropylene). Such material withstands heat of at least 130° C., preferably of at least 175° C. Preferably, the separator shows a tension resistance of at least 1 Nm.

Preferably, the material used for the filter is chemically resistant to O2 and to H2O, in particular resistant to a fraction of less than 1 ppm. In addition, the material of the filter is chemically resistant to one or more of 2,2,6,6-tetramethylpiperidine-1-oxyl, sodium hypochlorite (NaCIO) or sodium bromide (NaBr) subject to the type of electrolyte used. The filter material preferably withstands heat of at least 120° C., preferably of at least 175° C. Preferably, the separator shows a permeability curley value between 80 and 800, and preferably a tension resistance value of at least 1 Nm.

Preferably, the separator arrangement is used in a lithium ion battery. The battery may be a button cell battery, a different shaped or sized battery, or a battery pack. In a very preferred embodiment, the separator arrangement is used in an electrical vehicle battery for powering electric motors of a vehicle such as a car or a pedelec.

According to another aspect of the present invention, a battery is provided comprising a separator arrangement according to any of the preceding embodiments. In particular, such battery comprises a housing containing an electrolyte, and anode and a cathode in contact with the electrolyte, and the separator arrangement arranged for electrically separating the anode from the cathode, which separator arrangement preferably is immersed in the electrolyte, at least partially. Preferably the anode comprises lithium. In such battery, the filter preferably faces the anode, while the separator faces the cathode. In a different embodiment, the filter faces the anode while the separator faces the cathode. The battery preferably is a rechargeable battery

The electrolyte of the battery preferably is a lithium based electrolyte. In one embodiment, the electrolyte comprises lithium nickel manganese cobalt oxides LiNiₓMn_{y}Co_{z}O₂. In another embodiment, the electrolyte comprises lithium nickel manganese cobalt oxides LiNi_{1/3}Mn_{1/3}Co_{1/3}O₂.

According to another aspect of the present invention, a method is provided for manufacturing a separator arrangement. In such method, filter material is rolled off from a filter roll. The filter material preferably is provided as a rolled stripe on the filter roll. An unrolled portion of the filter material is guided into a first position. Also the separator material is provided as a rolled stripe on a separator roll. Hence, the separator material is rolled off from the separator roll. An unrolled portion of the separator material is guided into the first position next to the unrolled portion of the filter material. Accordingly, the unrolled portion of the filter material and the unrolled portion of the separator material are arranged next to each other, and specifically in parallel to each other in the first position, which first position represents the destination where the filter material and the separator material are cut from the respective rolls, thereby forming the separator arrangement.

Preferably, the first position is at the location of the manufacturing of the battery. Even more preferably, the first position is in a battery casing. Hence, the filter and the separator are only joined at the location of the manufacture of the battery, and even more preferably are only joined in the casing of the battery. Hence, it is not envisaged to pre-join or pre-assemble the filter and the separator and deliver the assembled separator arrangement to the location of battery manufacture. Instead, it is preferred to supply the filter material and the separator material, rolled on respective rolls, to the location of manufacture of the battery, and only there join the two materials for building the separator arrangement. In case the filter material and the separator material are only joined in the battery casing, only there the separator arrangement is formed.

The unwinding of the separator material from the separator roll and the unwinding of the filter material from the filter roll may take effect simultaneously. No specific order of any sequential unwinding shall be implied in the order of steps provided in the corresponding claim. The unwinding may be performed in a controlled process, e.g. by the aid of one or more electric motors for rotating the rolls, and/or by guiding means for guiding the unwound portions to the destination position.

The cutting of the filter material and the separator material preferably is executed by a single cutting tool, such as blade, simultaneously. Hence, filter and separator e.g. arranged on top of each other at the destination are simultaneously cut by the blade which preferably is part of an electrically controlled cutting tool.

Preferably, such manufacture is implemented in an automated manner, comprising an electronic control unit configured to control the unwinding of the filter material and the separator material, the positioning of the unwound portions if needed, and the cutting. Such control unit may in one embodiment be a control unit of a fully automated assembly for manufacturing batteries, and may implement further tasks such as controlling conveyor belts, supplying battery casings, controlling a filling station for filling the battery casings with an electrolyte, and, e.g. controlling a final assembly station for closing the battery casings by a cover each.

It is explicitly stated that all embodiments disclosed in connection with one aspect of the present invention shall also be considered disclosed in connection with the other aspects of the present invention.

### BRIEF DESCRIPTION OF THE DRAWINGS

The invention will be better understood and objects other than those set forth above will become apparent when consideration is given to the following detailed description of embodiments thereof. Such description makes reference to the annexed drawings, wherein:

FIG. 1 illustrates a separator arrangement in a perspective view, according to an embodiment of the present invention, as well as two schematic enlarged top views a) and b) on the two components of the separator arrangement;

FIG. 2 illustrates a schematic cut view of a battery, according to an embodiment of the present invention; and

FIG. 3 schematically illustrates a method for manufacturing a battery, according to an embodiment of the present invention.

### MODES FOR CARRYING OUT THE INVENTION

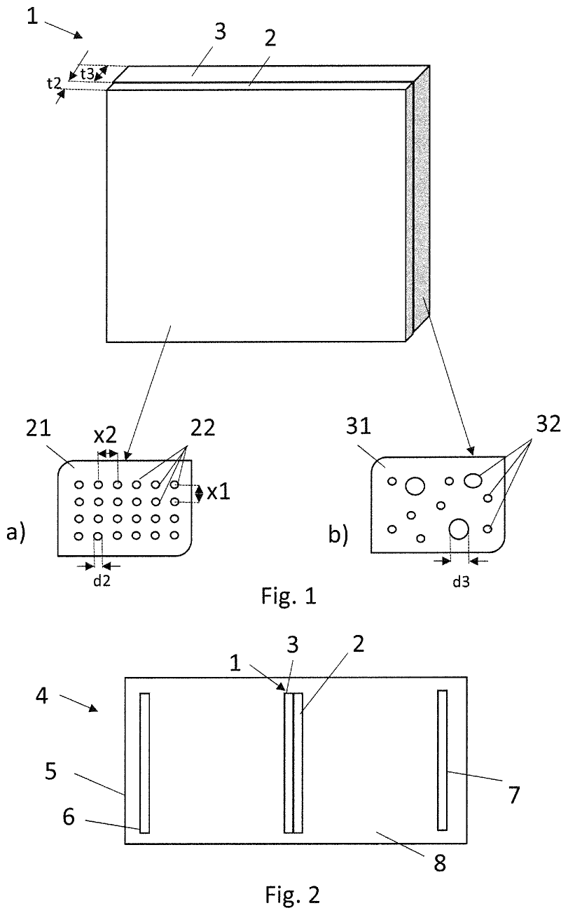

FIG. 1 illustrates a separator arrangement 1 in a perspective view according to an embodiment of the present invention. The separator arrangement comprises a separator 2 and a filter 3 arranged in parallel to each other, i.e. in planes parallel to each other. The separator 2 has a thickness t2. The filter 3 has a thickness t3, which presently exceeds the thickness t2 of the separator 2. Length and width, i.e. the other two dimensions of the separator 2 and the filter 3, correspond to each other. Separator 2 and filter 3 are arranged on top of each other, and in one example, may be attached to each other.

Diagrams 1a) and 1b) illustrate enlarged schematic portions of the separator 2 and the filter 3 respectively. As can be seen from diagram 1a), the separator 2 comprises a foil 21 having pores 22 of diameter d2. The pores 22 are of uniform size, and in particular of uniform diameter d2. The pores 22 are also arranged equidistant from each other, such that a distance x1 between rows of pores 22 is the same across all rows, and a distance x2 between columns of pores 22 is the same across all columns. In particular x1=x2, such that the pores 22 are arranged in the foil 21 in a uniform rectangular pattern.

In contrast, and as can be seen from diagram 1b), the filter 3 comprises a foil 31 having pores 32 of non-uniform diameter. Hence, one of the pores 32 may show diameter d3, while another pore 32 may show a diameter different from d3. Neither are the pores 32 of uniform size, nor are they arranged in a regular pattern. However, overall porosity of the filter 3 is less than the porosity of the separator 2.

FIG. 2 illustrates a schematic cut view of a battery 4 according to an embodiment of the present invention. The battery 4 includes a housing 5. In the housing 5, an anode 6 and a cathode 7 are immersed in an electrolyte 8. In addition, a separator arrangement 1 according to an embodiment of the present invention is arranged in the housing 5, and is immersed in the electrolyte 8. The separator arrangement 1 includes a separator 2 and a filter 3, such as e.g. illustrated in FIG. 1.

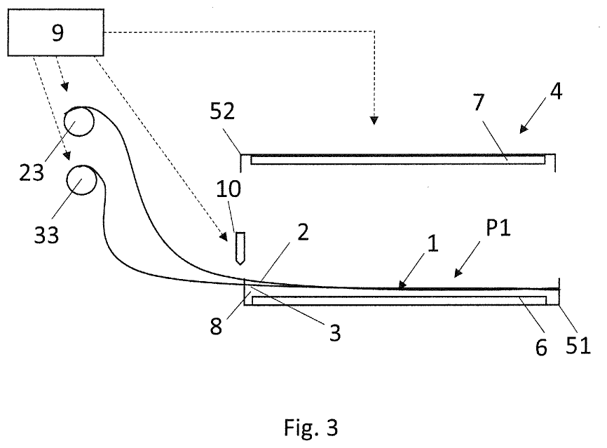

FIG. 3 illustrates a method for manufacturing a battery 4 according to an embodiment of the present invention. The scheme in particular shows a site for manufacturing the battery 4. At a workplace, a casing 51 with an opening serving as bottom part of a battery housing is supplied e.g. by some conveyor belt not shown. The casing 51 includes or represents an anode 6, for example, and is already filled with an electrolyte 8. A control unit 9 preferably controls the fully- or at least semi-automated manufacturing process. Accordingly, the control unit 9 evokes an unwinding of filter material from a filter roll 33, and separator material 2 from a separator roll 23. Guiding means—not shown, either passive such as baffles, or active such as deflectors—may be provided for guiding the unrolled filter material and the unrolled separator material to a first or destination position 21, which presently is inside the casing 51.

When having reached the destination position 21, a blade 10 or other cutting tool may be controlled by the control unit 9 to cut the separator 2 and the filter 3 from the rolled materials in one go. By such means, a separator arrangement 1 is generated already in the casing 51. In an additional step, the control unit 9 may trigger the closure of the casing 51 by means of a cover 52. The cover 52 preferably includes or represents the cathode 7. The cover 52 and the casing 51 are preferably electrically isolated from each other.

While there are shown and described presently preferred embodiments of the invention, it is to be distinctly understood that the invention is not limited thereto but may be otherwise variously embodied and practiced within the scope of the following claims.

1. Separator arrangement for a battery, comprising
a porous separator with a separator porosity, and
a porous filter with a filter porosity less than the separator porosity.

2. Separator arrangement according to claim 1,
wherein the separator porosity is 50% or more, and
wherein the filter porosity is less than 50%.

3. Separator arrangement according to claim 1,
wherein the separator porosity is 60% or more, and
wherein the filter porosity is less than 60%.

4. Separator arrangement according to claim 1,
wherein the separator porosity is 70% or more, and
wherein the filter porosity is less than 30%.

5. Separator arrangement according to claim 1,
wherein the separator comprises more than 2000 pores per cm², and
wherein the filter comprises less than 2000 pores per cm².

6. Separator arrangement according to claim 5,
wherein the separator comprises more than 3000 pores per cm², and
wherein the filter comprises less than 1500 pores per cm².

7. Separator arrangement according to claim 6,
wherein the separator comprises more than 4800 pores per cm², and
wherein the filter comprises less than 1200 pores per cm².

8. Separator arrangement according to claim 1,
wherein the pores of the separator are of uniform size, and
wherein the pores of the filter are of non-uniform size.

9. Separator arrangement according to claim 1,
wherein a diameter of the pores of the separator is between 5 μm and 95 μm.

10. Separator arrangement according to claim 1,
wherein a diameter of the pores of the filter is between 0.02 μm and 0.7 μm.

11. Separator arrangement according to claim 1,
wherein a thickness of the separator is less than 10 μm, and
wherein a thickness of the filter is equal to or more than 10 μm and is less than 35 μm.

12. Separator arrangement according to claim 11,
wherein a thickness of the separator is between 6 μm and 8 μm.

13. Separator arrangement according to claim 1,
wherein the filter is made of polypropylene.

14. Method for manufacturing a separator arrangement, comprising
rolling off filter material from a filter roll and guiding the unrolled portion of the filter material in a first position,
rolling off separator material from a separator roll and guiding the unrolled portion of the separator material in the first position next to the unrolled portion of the filter material, and
cutting off the filter material and the separator material thereby forming the separator arrangement.

15. Method for manufacturing a battery, comprising
building the separator arrangement from the separator material and the filter material at the location of manufacture of the battery as follows:
rolling off filter material from a filter roll and guiding the unrolled portion of the filter material in a first position,
rolling off separator material from a separator roll and guiding the unrolled portion of the separator material in the first position next to the unrolled portion of the filter material, and
cutting off the filter material and the separator material thereby forming the separator arrangement.

16. Method according to claim 15, comprising
providing a battery casing with an opening,
building the separator arrangement inside the battery casing wherein the separator material and the filter material are supplied through the opening,
closing the battery casing by a cover.

17. Battery, comprising a separator arrangement according to claim 1.

18. Battery according to claim 17, comprising
a lithium based electrolyte the separator arrangement is immersed in, wherein the electrolyte comprises lithium nickel manganese cobalt oxides LiNiₓMn_{y}Co_{z}O₂.

19. Battery according to claim 17, comprising
an anode and a cathode,
wherein the filter faces the anode.

20. Battery according to claim 1,
wherein the battery is a rechargeable battery.
